(19) United States
(12) Patent Application Publication
(10) Pub. No.: US 2015/0004942 A1
(43) Pub. Date: Jan. 1, 2015

(54) HOSTING A VOICE RESPONSE SYSTEM ON A MOBILE PHONE

(71) Applicant: International Business Machines Corporation, Armonk, NY (US)

(72) Inventors: Anupam Jain, Gurgaon (IN); Vivek Sanghi, New Delhi (IN)

(21) Appl. No.: 13/930,427

(22) Filed: Jun. 28, 2013

(51) Int. Cl. H04M 3/51; H04W 4/00

(52) U.S. Cl. CPC H04M 3/5166; H04W 4/00
USPC 455/412.1

(57) ABSTRACT

Methods and arrangements for operating a voice response system. A voice response system is installed at a mobile phone, the voice response system comprising an event receiver and a host manager. The voice response system is employed to receive an incoming communication at the mobile phone, and the event receiver is employed to receive notification of an event from at least one component of the mobile phone. The host manager is employed to instruct at least one component of the mobile phone to respond to the incoming communication based on notification of the event, wherein the at least one component is capable of: providing a response to a source of the incoming communication, and processing the incoming communication locally at the mobile phone. Other variants and embodiments are broadly contemplated herein.

### BACKGROUND

Generally, voice response systems normally include client-server architecture where a phone calls a server. Voice applications are hosted on a platform which includes multiple servers and telephony equipment. Such infrastructure can be costly, and in order to share the costs there is usually a need to rely on service providers.

While enterprise-based voice applications may require numerous features, personal voice applications generally need little more than very basic features. For instance, speech recognition may not be required in such applications, while they also tend to function well if a large number of people are not making calls at the same time. Thus, the scaled-back needs inherent in personal voice applications appear incongruous with the scale and costliness of the larger-scale infrastructure normally associated with external service providers.

### BRIEF SUMMARY

In summary, one aspect of the invention provides a method of operating a voice response system, said method comprising: utilizing at least one processor to execute computer code configured for: installing a voice response system at a mobile phone, the voice response system comprising an event receiver and a host manager; employing the voice response system to receive an incoming communication at the mobile phone; employing the event receiver to receive notification of an event from at least one component of the mobile phone; and employing the host manager to instruct at least one component of the mobile phone to respond to the incoming communication based on notification of the event, wherein the at least one component is capable of: providing a response to a source of the incoming communication, and processing the incoming communication locally at the mobile phone.

Another aspect of the invention provides an apparatus comprising: at least one processor; and a computer readable storage medium having computer readable program code embodied therewith and executable by the at least one processor, the computer readable program code comprising: computer readable program code configured to install a voice response system at a mobile phone, the voice response system comprising an event receiver and a host manager; computer readable program code configured to employ the voice response system to receive an incoming communication at the mobile phone; computer readable program code configured to employ the event receiver to receive notification of an event from at least one component of the mobile phone; and computer readable program code configured to employ the host manager to instruct at least one component of the mobile phone to respond to the incoming communication based on notification of the event, wherein the at least one component is capable of: providing a response to a source of the incoming communication, and processing the incoming communication locally at the mobile phone.

An additional aspect of the invention provides a computer program product comprising: a computer readable storage medium having computer readable program code embodied therewith, the computer readable program code comprising: computer readable program code configured to install a voice response system at a mobile phone, the voice response system comprising an event receiver and a host manager; computer readable program code configured to employ the voice response system to receive an incoming communication at the mobile phone; computer readable program code configured to employ the event receiver to receive notification of an event from at least one component of the mobile phone; and computer readable program code configured to employ the host manager to instruct at least one component of the mobile phone to respond to the incoming communication based on notification of the event, wherein the at least one component is capable of: providing a response to a source of the incoming communication, and processing the incoming communication locally at the mobile phone.

A further aspect of the invention provides a method comprising: receiving an incoming phone call or text at a mobile phone; instructing at least one component of the mobile phone to respond to the incoming phone call or text based on a source of the incoming communication; wherein to respond comprises invoking: a preset script based on a source of the incoming phone call or text; and a template for interaction with a source of the incoming phone call or text.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a conventional voice response system

FIG. 2 illustrates a voice response system in accordance with at least one embodiment of the invention.

FIG. 3 illustrates an event receiver.

FIG. 4 illustrates a host manager and other components.

FIG. 5 sets forth a process more generally for operating a voice response system.

FIG. 6 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

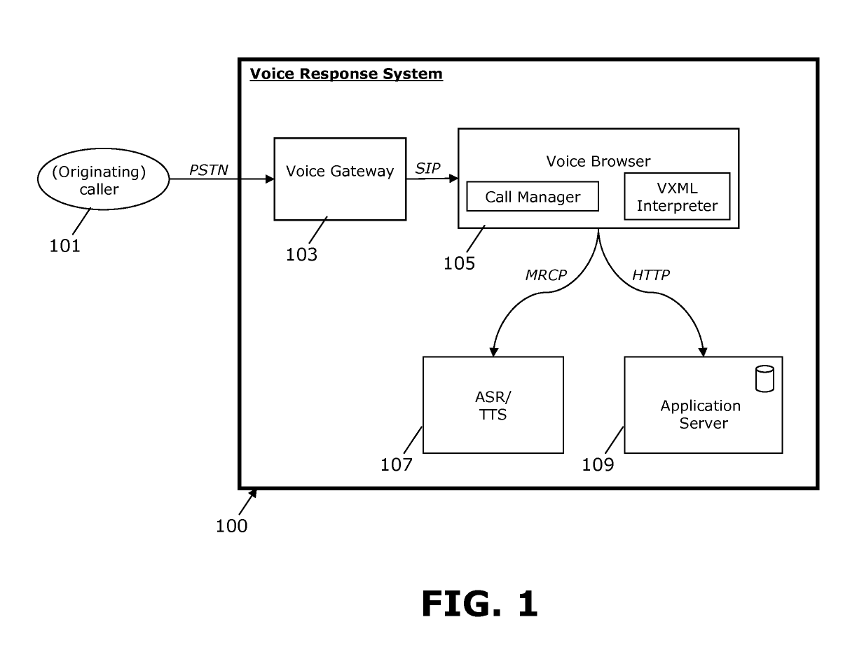

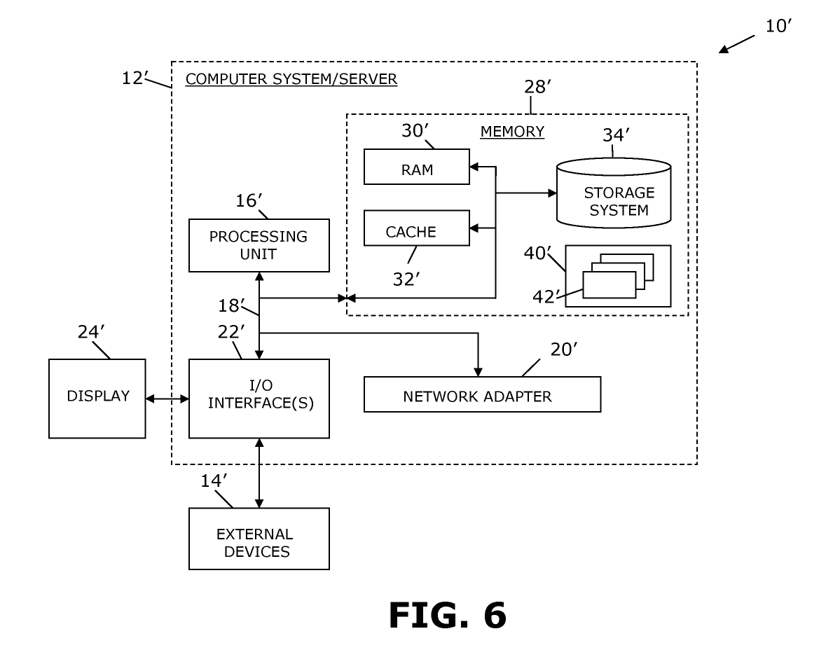

Specific reference will now be made herebelow to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 6. In accordance with an example embodiment, most if not all of the process steps, components and outputs discussed with respect to FIGS. 1-5 can be performed or utilized by way of a processing unit or units and system memory such as those indicated, respectively, at 16′ and 28′ in FIG. 6, whether on a server computer, a client computer, a node computer in a distributed network, or any combination thereof.

Broadly contemplated herein, in accordance with at least one embodiment of the invention, are methods and arrangements for permitting a mobile phone to host an end-to-end voice response system for individuals, without any need to use the services of an external service provider.

As such, in accordance with at least one embodiment of the invention, a voice response system can be hosted on a mobile phone simply by installing an application (or “app”) on the phone, thus obviating any need for external hardware. A variety of interaction templates can also be made available that are directly embedded/coded into the system, such that (for instance) there is no need to interpret/browse VXML (voice XML, or voice extensible markup language) scripts as in the case of conventional voice browsers. Such interaction templates are encountered by an individual calling in to the voice response system. Examples of such interaction templates can include, but are by no means limited to, a voice blog (e.g., such that an incoming caller can listen to the callee's voice blog), a discussion forum, enhanced voicemail (which can be interactive and customizable) and music (e.g., a favorite music collection and reviews of music, etc.).

In accordance with at least one embodiment of the invention, host availability can be updated on an ongoing basis. Thus, if the phone is moving or in transit, any incoming call can be diverted to the voice response system (e.g., this may be an advantage when a user is driving and does not wish to answer the phone). GPS (global positioning system)-based location information can provide information to the caller (e.g., “the callee is within 2 kilometers right now”). If the phone is busy or the callee does not answer, an incoming call can be diverted to the voice response system. (In this vein, to divert when ‘busy’, a dual SIM [subscriber identity module] on the phone can be employed.)

By way of other features, in accordance with at least one embodiment of the invention, a voice response system can easily provide SMS (short message service) support. Particularly, the system can process SMSs itself and then send back relevant information (via SMS also) to the caller, without the need for a separate SMS gateway. For instance, an SMS sent to the phone with the format “host location” can return the name of the city where the callee's phone is currently located (which information, itself, can be established via a preset in the voice response system).

In accordance with at least one embodiment of the invention, a voice response system can easily integrate with other applications on the phone. For instance, in integrating with social media applications, the voice response system can playback or return (to incoming callers) a latest status message of the callee from a social media profile.

In accordance with at least one embodiment of the invention, an ongoing intervention capability can also be enabled. Particularly, the callee can monitor the call flow of a voice application on his/her phone and intervene manually when there is a recognized need. For instance, he/she can change the flow of the call within the voice application on a “realtime” or current basis, can choose to talk to the caller, or can conference into the call and navigate along with the caller (or even assist the caller in accessing restricted areas by entering any needed access codes, etc.).

FIG. 1 illustrates an example of a conventional voice response system 100, hosted at an external service provider. As shown, an incoming call (from an originating caller 101) is routed (e.g., via PSTN, or public switched telephone network) to a voice gateway 103, which itself is in connection (via SIP, or session initiation protocol) with a voice browser 105. The voice browser 105 includes a call manager and a VXML interpreter, and is in connection (e.g., via MRCP, media resource control protocol) with an automatic speech recognition and text-to-speech (ASR/TTS) system 107, as well as (e.g., via HTTP, hypertext transfer protocol) an application server 109. While all these components may be useful for an enterprise or other large-scale setting, some of them, each possibly involving a relatively complex functionality, may not at all be needed in the context of a personal voice response system.

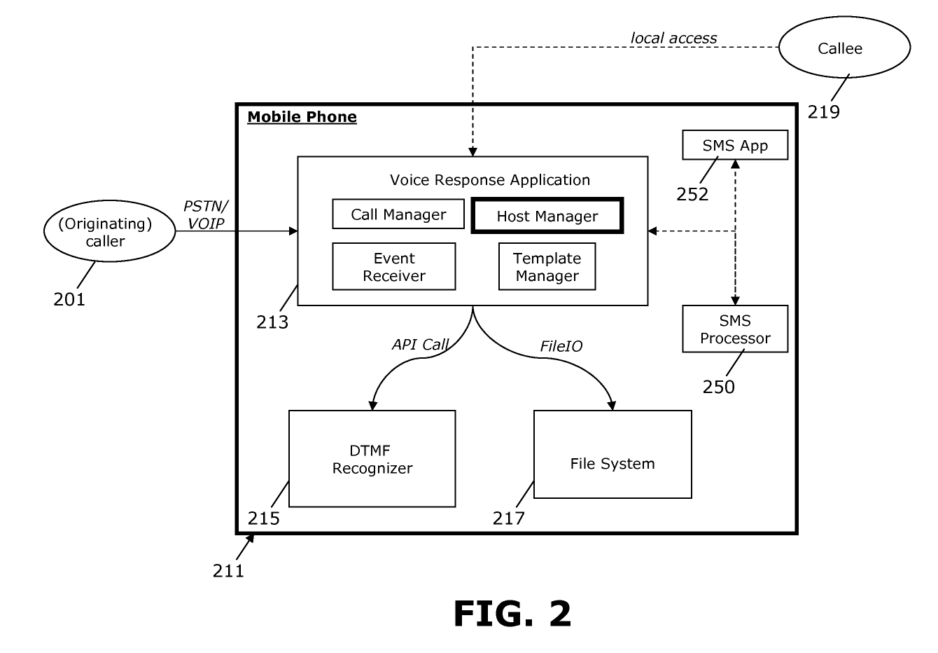

Accordingly, FIG. 2 illustrates a voice response system in accordance with at least one embodiment of the invention, better suited to a personal scale. As shown, incoming calls (via PSTN or VOIP [voice over Internet Protocol]), from originating caller 201 to a callee's mobile phone 211, are routed directly to a voice response application 213 hosted on the phone 211. The voice response application 213 includes a call manager, host manager, event receiver, SMS processor and template manager. The voice response application 213 is also in communication (e.g., via an API [application programming interface] call) with a DTMF (dual-tone multifrequency) recognizer 215 and a file system 217, both also hosted on the phone 211. The callee 219 can also, at any time, freely access the voice response application 213 locally and directly (via his/her phone 211).

As such, by way of general features, in accordance with at least one embodiment of the invention, the voice response application 213 indeed can be installed directly on the mobile phone 211 and does not need any external hardware. The event receiver will receive events from other applications/sensors on the phone and send them to the host manager for the latter to instruct other components of certain actions (e.g., diverting the call, updating a social media status message, etc.). The template manager residing in the voice response application 213 can contain a set of “inbuilt” voice scripts which will be invoked based on the number called from (that is, the number of the originating caller 201), based on associated information received from the call manager. SMSs received by the host manager can be sent to the phone's already-inbuilt SMS processor 250 which can then be interpreted and replied back and sent via the phone's own SMS application (app) 252. This will permit the provision of host information or voice application information over an SMS without a need for an external SMS gateway.

In accordance with at least one embodiment of the invention, instead of an MRCP Client, the voice response application 213 will use the phone's own DTMF recognizer 215 to obtain user input, with instructions sent using the available API on the respective OS. Instead of an HTTP client, the voice response application 213 can use the phone's file IO (input/output) to store and retrieve user information (e.g., in text or audio files of a file system 217); instructions here can be sent using the FILEIO API on the respective OS.

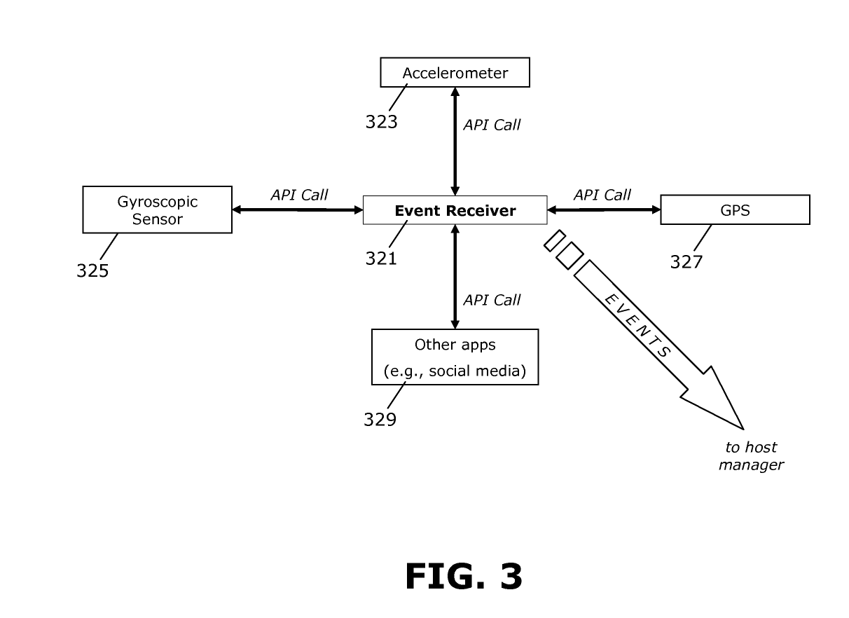

FIG. 3 illustrates an event receiver 321, in accordance with at least one embodiment of the invention. As shown, the event receiver may be in communication with an accelerometer 323, a gyroscopic sensor 325, a GPS 327, and other applications 329 (e.g., social media applications), via platform APIs provided for these. The accelerometer 323 can detect if the phone is moving, and thereby forward calls to the voice response application as discussed above, while the gyroscopic sensor 325 can detect rotation (and thus, not necessarily translation) of the phone, thus inferring that the user may be doing something on the phone while remaining in place (and thus may not be available to take a call, thereby prompting, e.g., forwarding to the voice response application). As soon as an event is received by the event receiver 321, e.g., by one of the other components 323-329 shown here, it is sent to the host manager (see FIG. 2) for further processing.

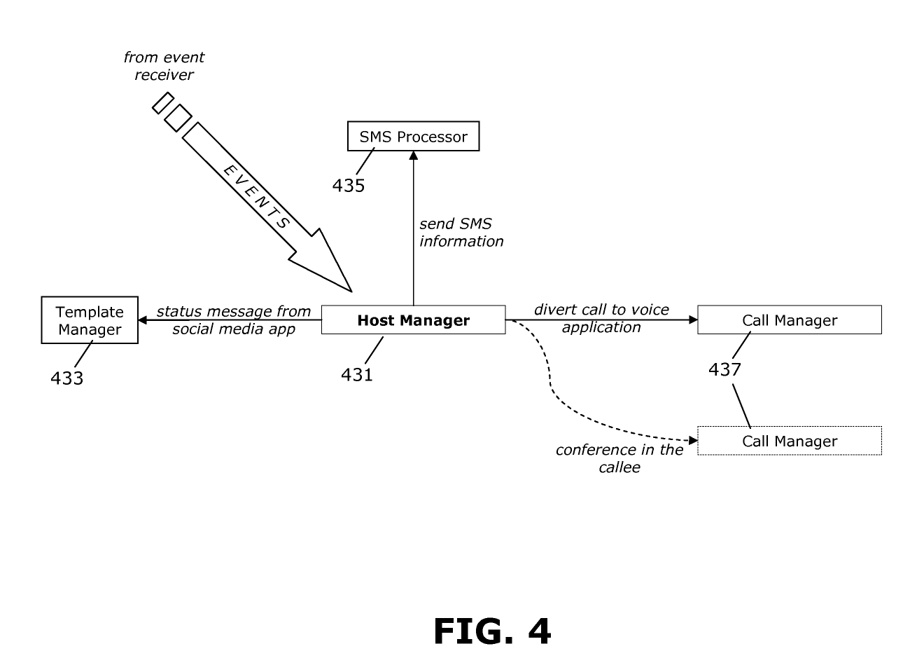

FIG. 4 illustrates a host manager 431 and other components, in accordance with at least one embodiment of the invention. As shown, the host manager 321 coordinates with other components in order to send instructions to the same, based on the events received by the event receiver (see FIGS. 2 and 3). Some examples of such instructions can include, but are by no means limited to: a status message from a social media application sent to a template manager 433; SMS information sent to the phone's SMS processor 435; and to the phone's call manager 437, instructions to divert a call to the voice response application or to conference in the callee.

By way of advantages enjoyed with a voice response system in accordance with at least one embodiment of the invention, it will be appreciated that there is no need to set up any external hardware; as such, a user's phone is the only device needed to set up the voice response system, end-to-end. Drastic reductions in costs can be enjoyed, while the voice application can still be accessed from other (including, external) voice response systems. There is no need to deploy complete VXML scripts; templates only need be selected and customized. Tremendous bandwidth is saved, since all operations between a host and voice application are now local. Business continuity teams can send critical information on voice response systems that happen to run on banks of mobile phones since mobile phones and associated networks are more likely to survive/recover from disasters or contingencies than landline networks and data centers. In other words, when there is a need for disaster recovery with respect to mobile phones each containing its own voice response system or application, critical information such as identifying information can be retrieved right from there, from each phone.

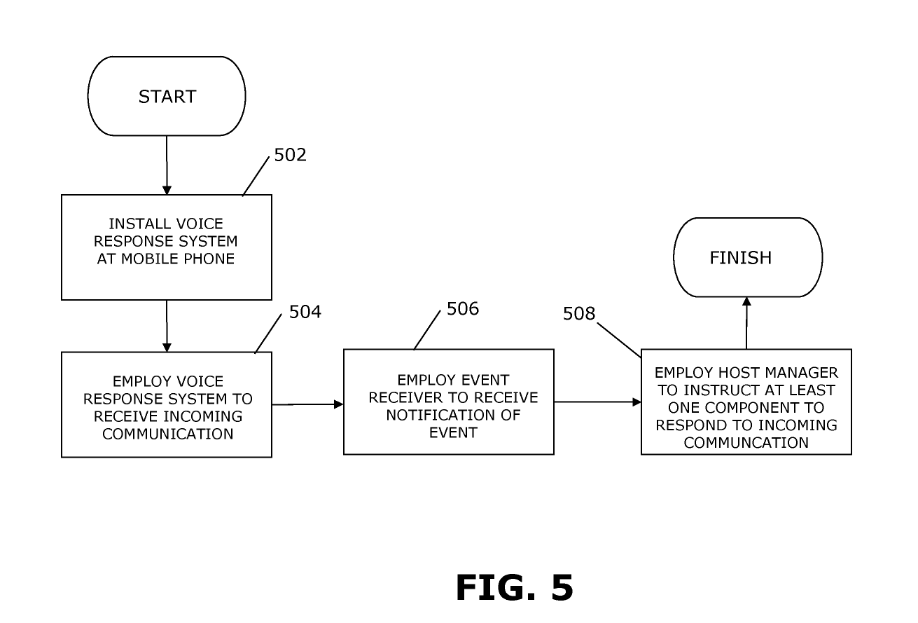

FIG. 5 sets forth a process more generally for operating a voice response system, in accordance with at least one embodiment of the invention. It should be appreciated that a process such as that broadly illustrated in FIG. 5 can be carried out on essentially any suitable computer system or set of computer systems, which may, by way of an illustrative and non-restrictive example, include a system such as that indicated at 12′ in FIG. 6. In accordance with an example embodiment, most if not all of the process steps discussed with respect to FIG. 5 can be performed by way of a processing unit or units and system memory such as those indicated, respectively, at 16′ and 28′ in FIG. 6.

As shown in FIG. 5, in accordance with at least one embodiment of the invention, a voice response system is installed at a mobile phone, the voice response system comprising an event receiver and a host manager (502). The voice response system is employed to receive an incoming communication at the mobile phone (504), and the event receiver is employed to receive notification of an event from at least one component of the mobile phone (506). The host manager is employed to instruct at least one component of the mobile phone to respond to the incoming communication based on notification of the event, wherein the at least one component is capable of: providing a response to a source of the incoming communication, and processing the incoming communication locally at the mobile phone (508).

Referring now to FIG. 6, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture. Such an article of manufacture can include instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method of operating a voice response system, said method comprising:
utilizing at least one processor to execute computer code configured for:
installing a voice response system at a mobile phone, the voice response system comprising an event receiver and a host manager;
employing the voice response system to receive an incoming communication at the mobile phone;
employing the event receiver to receive notification of an event from at least one component of the mobile phone; and
employing the host manager to instruct at least one component of the mobile phone to respond to the incoming communication based on notification of the event, wherein the at least one component is capable of: providing a response to a source of the incoming communication, and processing the incoming communication locally at the mobile phone.

2. The method according to claim 1, wherein the event comprises at least one of: a GPS location of a user of the mobile phone, a social media status of a user of the mobile phone, a busy status of a user of the mobile phone, translational movement of the mobile phone, and rotational movement of the mobile phone.

3. The method according to claim 1, wherein the incoming communication is received from at least one of: an accelerometer, a gyroscopic sensor, a GPS, and a social media application.

4. The method according to claim 1, wherein:
the incoming communication comprises an incoming call; and
said at least one component responds to the incoming communication via performing at least one of: sending text to a source of the incoming call; providing a voice-based message; conveying a busy status of a user of the mobile phone; conveying a social media status of a user of the mobile phone; diverting the incoming call; permitting a user of the mobile phone to conference into the incoming call.

5. The method according to claim 1, wherein said at least one component responds to the incoming communication via responding based on a source of the incoming communication.

6. The method according to claim 5, wherein said responding based on a source of the incoming communication comprises invoking a preset script based on a source of the incoming communication.

7. The method according to claim 1, wherein said at least one component responds to the incoming communication via accepting manual user input to assist in responding to the incoming call.

8. The method according to claim 7, wherein said accepting of manual user input comprises employing a dual-tone multifrequency recognizer of the mobile phone.

9. The method according to claim 1, wherein said at least one component responds to the incoming communication via sending text to a source of the incoming communication.

10. The method according to claim 1, comprising storing user information in a file input/output of the mobile phone.

11. The method according to claim 1, wherein said employing of the host manager comprises employing the host manager to invoke a template for interaction with a source of the incoming communication.

12. The method according to claim 11, wherein the template comprises at least one of: a voice blog, a discussion forum, enhanced voicemail, and a music-based template.

13. The method according to claim 1, wherein the incoming communication comprises at least one of: an incoming call, and an incoming SMS message.

14. The method according to claim 1, wherein said at least one component responds to the incoming communication via at least one of: providing a response to a source of the incoming communication, and processing the incoming communication locally at the mobile phone.

15. An apparatus comprising:
at least one processor; and
a computer readable storage medium having computer readable program code embodied therewith and executable by the at least one processor, the computer readable program code comprising:
computer readable program code configured to install a voice response system at a mobile phone, the voice response system comprising an event receiver and a host manager;
computer readable program code configured to employ the voice response system to receive an incoming communication at the mobile phone;
computer readable program code configured to employ the event receiver to receive notification of an event from at least one component of the mobile phone; and
computer readable program code configured to employ the host manager to instruct at least one component of the mobile phone to respond to the incoming communication based on notification of the event, wherein the at least one component is capable of: providing a response to a source of the incoming communication, and processing the incoming communication locally at the mobile phone.

16. A computer program product comprising:
a computer readable storage medium having computer readable program code embodied therewith, the computer readable program code comprising:
computer readable program code configured to install a voice response system at a mobile phone, the voice response system comprising an event receiver and a host manager;
computer readable program code configured to employ the voice response system to receive an incoming communication at the mobile phone;
computer readable program code configured to employ the event receiver to receive notification of an event from at least one component of the mobile phone; and
computer readable program code configured to employ the host manager to instruct at least one component of the mobile phone to respond to the incoming communication based on notification of the event, wherein the at least one component is capable of: providing a response to a source of the incoming communication, and processing the incoming communication locally at the mobile phone.

17. The computer program product according to claim 16, wherein the event comprises at least one of: a GPS location of a user of the mobile phone, a social media status of a user of the mobile phone, a busy status of a user of the mobile phone, translational movement of the mobile phone, and rotational movement of the mobile phone.

18. The computer program product according to claim 16, wherein to receive notification comprises receiving notification from at least one of: an accelerometer, a gyroscopic sensor, a GPS, and a social media application.

19. The computer program product according to claim 15, wherein:
the incoming communication comprises an incoming call; and
to respond comprises performing at least one of: sending text to a source of the incoming call; providing a voice-based message; conveying a busy status of a user of the mobile phone; conveying a social media status of a user of the mobile phone; diverting the incoming call; and permitting a user of the mobile phone to conference into the incoming call.

20. A method comprising:
receiving an incoming phone call or text at a mobile phone;
instructing at least one component of the mobile phone to respond to the incoming phone call or text based on a source of the incoming communication;
wherein to respond comprises invoking:
a preset script based on a source of the incoming phone call or text; and
a template for interaction with a source of the incoming phone call or text.
